(19) United States
(12) Patent Application Publication
(10) Pub. No.: US 2018/0025060 A1
(43) Pub. Date: Jan. 25, 2018

(54) Information Providing Device

(71) Applicant: TOYOTA JIDOSHA KABUSHIKI KAISHA, Toyota-shi (JP)

(72) Inventors: Hidehiko SASAKI, Nagoya-shi (JP); Tomohito SONODA, Nagoya-shi (JP)

(73) Assignee: TOYOTA JIDOSHA KABUSHIKI KAISHA, Toyota-shi (JP)

(21) Appl. No.: 15/648,573

(22) Filed: Jul. 13, 2017

(30) Foreign Application Priority Data
Jul. 21, 2016 (JP) 2016-143574

(51) Int. Cl. G06F 17/30

(52) U.S. Cl. CPC G06F 17/30528; G06F 17/3087; G06F 17/30867; G06F 17/3053; G06F 17/30241

(57) ABSTRACT

An information providing device includes a server that is configured to: acquire position information representing a position of a user; derive a score of a behavior of the user at the position; analyze a taste of the user or a behavior tendency of the user based on the score; select recommendation information based on the taste or the behavior tendency of the user; and send the selected recommendation information to a terminal of the user.

### INCORPORATION BY REFERENCE

The disclosure of Japanese Patent Application No. 2016-143574 filed on July 21, 2016 including the specification, drawings and abstract is incorporated herein by reference in its entirety.

### BACKGROUND

### 1. Technical Field

The present invention relates to an information providing device.

### 2. Description of Related Art

In the related art, a mobile communication system including a plurality of mobile terminals and an information center is proposed. In this mobile communication system, the information center receives position information and upload data sent from mobile terminals and, based on the received position information, searches for information or a service and then sends the information or the service, which has been searched for, to the mobile terminals (for example, see Japanese Patent Application Publication No. 10-013961 (JP 10-013961 A)).

### SUMMARY

Meanwhile, the mobile communication system according to the related art provides information according to the position of the user of a mobile terminal. However, this mobile communication system has room for further improvement in that the system should provide appropriate information according to a user's taste and behavior tendency.

The present invention provides an information providing device that can select appropriate information according to a user's taste and behavior tendency and provide the selected information.

An information providing device according to an aspect of the present disclosure includes a server configured to: acquire position information representing a position of a user; derive a score of a behavior of the user at the position; analyze a taste of the user or a behavior tendency of the user based on the score; select recommendation information based on the taste or the behavior tendency of the user; and send the selected recommendation information to a terminal of the user.

The information providing device according to the above aspect determines the user's taste or the user's behavior tendency that reflects the score of the behavior of the user at the position and selects the recommendation information that suits the user's taste or the user's behavior tendency that has been determined.

Therefore, the present invention can provide the information providing device that can select and provide appropriate information according to user's taste and behavior tendency.

In the above aspect, the server may be configured to derive, as the score of the behavior, a score of a service or a score that represents a degree of staying of the user at the position, the score of the service being related to the position and being provided to the terminal at the position via a network or a communication line.

Therefore, the user's taste or the user's behavior tendency can be determined by reflecting the score of the service or the score indicating the degree of staying at the position.

In the above aspect, the server may be configured to analyze that the user has a higher preference to the taste or a higher level of the tendency as the score is larger.

According to the above configuration, the server is possible to analyze that the user has a higher preference to the taste or a higher level of the tendency as the behavior has a higher score.

The information providing device according to the above aspect may further include a spot database in which position information representing a position of a spot included in map data is associated with a category of the spot. And the server may be configured to: generate a behavior history by registering a spot corresponding to the acquired position of the user, and the score in such a way that the spot and the score are associated, the behavior history representing the behavior of the user; and extract a category of a spot corresponding to the position, included in the behavior history, where the score is equal to or larger than a predetermined value, as the taste of the user or the behavior tendency of the user.

According to the above configuration, the behavior history is generated by registering the spot actually visited by the user and the score in such a way that the spot and the score are associated, and the category of a spot corresponding to the position where the score is equal to or larger than a predetermined value is obtained from the spot database.

Therefore, the category of a spot with a high score can be extracted as the user's taste or the user's behavior tendency.

In the above aspect, the server may be configured to: calculate a ratio of a total of scores corresponding to a spot of a particular category included in the behavior history to a total of all scores included in the behavior history; generate, for the particular category, a group of a plurality of users whose degree of matching in the ratio is equal to or larger than a predetermined degree; and select the recommendation information, selected for other users in the plurality of users in the group, as recommendation information that suits the taste or the behavior tendency of the user.

According to the above configuration, the degree of interest of the users with respect to the spot of a particular category can be calculated, and a plurality of users having a similar degree of interest can be grouped.

Therefore, the recommendation information provided to each user for a particular category can be shared within the group. This can help to increase spread and deepness of hobbies and the like.

In the above aspect, the score may be a degree of importance of a spot at the position for the user.

According to the above configuration, the recommendation information reflecting the degree of importance to the user about the spot can be provided.

In the above aspect, the server may be configured to derive a score based on at least one of content of a service for the position provided to the terminal via a network or a communication line at the position and a length of time during which the user stayed at the position, as the score of the behavior of the user.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing a vehicle 10 and an information providing device 100;

FIG. 2 is a diagram showing a functional configuration of an on-vehicle apparatus 20, a smartphone terminal 30, and the information providing device 100;

FIG. 3 is a diagram showing the position information on the vehicles 10;

FIG. 4 is a diagram showing a check-in list;

FIG. 5 is a diagram showing a guide history list;

FIG. 6 is a diagram showing importance degree threshold data;

FIG. 7 is a diagram showing a behavior history;

FIG. 8 is a flowchart showing the processing performed by a behavior history generation unit 115 to generate a behavior history; and

FIG. 9 is a diagram showing the degrees of interest X_{IT}, X_{FR}, X_{JP}, and X_{FF} of a plurality of users in each of the Italian-style food, French-style food, Japanese-style food, and fast food.

### DETAILED DESCRIPTION OF EMBODIMENTS

Embodiments in which an information providing device according to the present invention is applied will be described below.

### First Embodiment

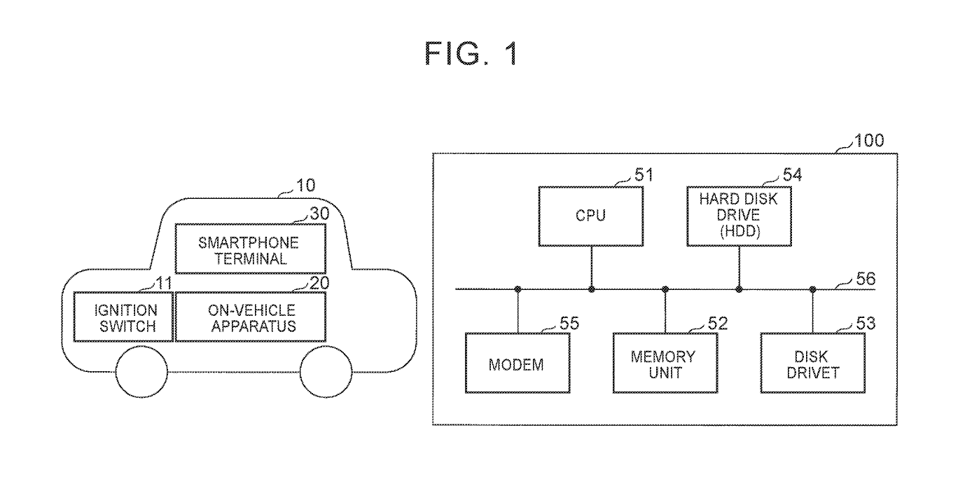

FIG. 1 is a diagram showing a vehicle 10 and an information providing device 100.

The vehicle 10 is, for example, a Hybrid Vehicle (HV), a Plug-in Hybrid Vehicle (PHV), an Electric Vehicle (EV), a gasoline engine vehicle, a diesel engine vehicle, or the like. The vehicle 10 has an ignition switch 11. The vehicle 10 has mounted thereon an on-vehicle apparatus 20 capable of communicating with the information providing device 100. The user of the vehicle 10 has a smartphone terminal 30.

The ignition switch 11 is a switch for switching the power supply state of the vehicle 10. The power supply state includes an ignition-on mode in which electric power is supplied to all the electrical components to enable the vehicle 10 to travel, an ignition-off mode in which the electric power supply to the electrical components is stopped, and an accessory mode in which power can be supplied only to some the electrical components such as the navigation device and the power window. Even in the ignition-off mode, electric power is supplied to some of the electrical components.

The hardware configuration of the information providing device 100 implemented in a computer system, such as a server, will be described below.

The information providing device 100 includes a CPU 51, a memory unit 52 including a RAM or a ROM, a disk drive 53 such as a Compact Disc Read Only Memory (CD-ROM) or Digital Video Disc Read Only Memory (DVD-ROM), a Hard Disk Drive (HDD) 54, and a modem 55. These components are interconnected by a bus 56. In addition, the information providing device 100 may include a display such as a liquid crystal monitor, a keyboard, and a mouse.

A program that causes the server (computer system) to function as the information providing device 100 is downloaded from another computer system via the disk drive 53 or the modem 55. The program is input to the server (computer system) for compilation.

The information providing device 100 described above carries out wireless communication with the on-vehicle apparatus 20 and the smartphone terminal 30 via the modem 55.

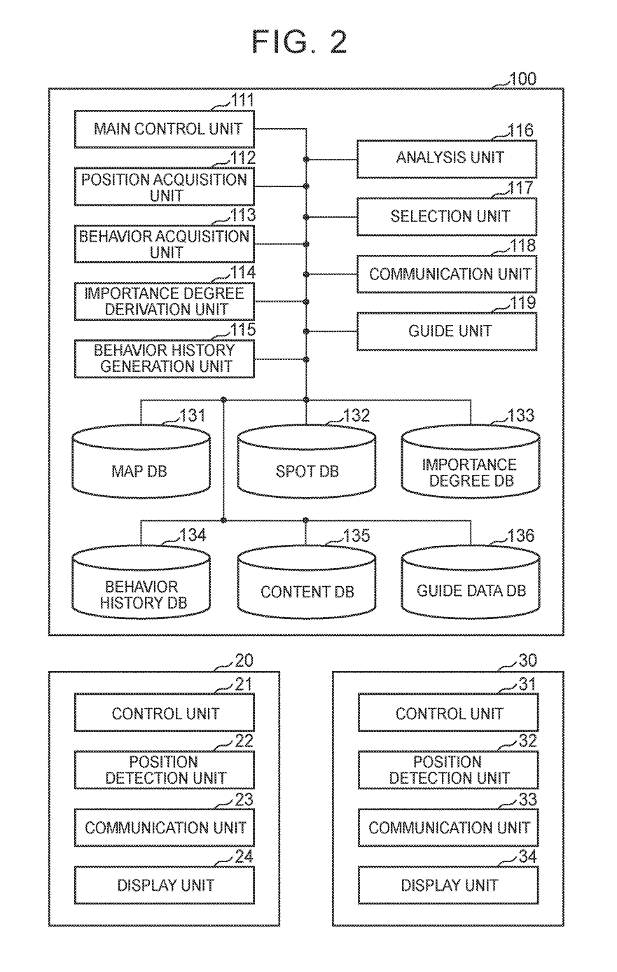

FIG. 2 is a diagram showing a functional configuration of the on-vehicle apparatus 20, the smartphone terminal 30, and the information providing device 100. The on-vehicle apparatus 20 and the smartphone terminal 30 shown in the figure are examples of user terminals.

The on-vehicle apparatus 20 includes a control unit 21, a position detection unit 22, a communication unit 23, and a display unit 24. The on-vehicle apparatus 20 is, for example, a navigation device. In the on-vehicle apparatus 20, an application is installed that functions like a tour guide for guiding the user around tourist spots, such as sightseeing spots and other facilities, near the current location according to the position data detected by the position detecting unit 22. Guiding the user around sightseeing spots or the like is an example of position-related services provided to the on-vehicle apparatus 20 of the user via a network or a communication line.

The control unit 21 performs various types of control processing for implementing the functions and operations of the on-vehicle apparatus 20. For example, the control unit 21 causes the display unit 24 to display the image of a map and the current location of the vehicle 10, detected by the position detection unit 22, to allow the user to search for a route to the destination or to output the information on a route.

In addition, the control unit 21 receives a signal (hereinafter referred to as an ignition signal), which indicates that the ignition ON/OFF state has been switched, from the ignition switch 11 (see FIG. 1). When the ON/OFF state of the ignition switch is switched, the control unit 21 causes communication unit 23 to send the ignition signal and the data, which represents the identification (ID) of the on-vehicle apparatus 20, to the information providing device 100. In addition, the control unit 21 causes the communication unit 23 to send the position data, detected by the position detection unit 22, and the data, representing the ID of the on-vehicle apparatus 20, to the information providing device 100 at predetermined time intervals.

In addition, the control unit 21 receives guidance data, such as data on the sightseeing spots, from the information providing device 100 via the communication unit 23, and outputs the voice guidance information. In addition, the control unit 21 causes the display unit 24 to display recommendation information received from the information providing device 100 via the communication unit 23. In this case, the control unit 21 may cause the display unit 24 to display the recommendation information and, at the same time, read the contents of the recommended information by voice guidance. The recommendation information refers to the information selected by the information providing device 100 according to user's taste and behavior tendency for providing the user with the information recommended to the user.

The position detection unit 22 may be any device that can detect the position of the vehicle 10. The position detection unit 22, such as a navigation device, detects the latitude and longitude of the current position of the vehicle 10 based on the signal obtained from the Global Positioning System (GPS) satellites and outputs the position data representing the latitude and longitude of the current position. The position detection unit 22 may further include a device such as an atmospheric pressure sensor capable of acquiring the altitude information. In this case, the position data may include the information indicating the altitude in addition to the information indicating the latitude and longitude.

The communication unit 23, which is a device that carries out bidirectional wireless communication with the information providing device 100, can be regarded as a Data Communication Module (DCM). Wireless communication is communication over a communication line such as Third Generation (3G), Fourth Generation (4G), or Long Term Evolution (LTE). It should be noted that the communication unit 23 may be provided outside the housing of the on-vehicle apparatus 20. The communication unit 23, though described as a unit included in the on-vehicle apparatus 20 in this specification, may be the smartphone terminal 30 of the user.

The display unit 24 is a display, for example, a liquid crystal panel or an organic Electroluminescence (EL) panel. The display unit 24 is arranged, for example, inside the dashboard, center console, meter panel, or the like. The display unit 24 may be a head-up display.

The image and information displayed by the display unit 24 are controlled by the control unit 21. The display unit 24 displays the image of a map output by the navigation device, the current position of the vehicle 10 detected by the position detection unit 22, the information provided by the information providing device 100, and the like.

The smartphone terminal 30 includes a control unit 31, a position detection unit 32, a communication unit 33, and a display unit 34.

The control unit 31 is a part that performs control processing necessary for the operation of the smartphone terminal 30.

The position detection unit 32 may be any device capable of detecting the position of the smartphone terminal 30. In this specification, the position of the smartphone terminal 30 is considered to be the position where the user is present. The position detection unit 32 detects the latitude and longitude of the current position based on the signal acquired from the GPS satellites and outputs the position data representing the latitude and longitude of the current position. The position detection unit 32 may further include a device such as an atmospheric pressure sensor capable of acquiring the altitude information.

The communication unit 33 is a functional representation of the communication device of the smartphone terminal 30. The communication unit 33 carries out communication over a communication line such as 3Q 4G, or LTE. The display unit 34 is a display, for example, a liquid crystal panel or an organic Electroluminescence (EL) panel. The image displayed on the display unit 34 is controlled by the control unit 31.

In the smartphone terminal 30, the program of an application having the check-in function, which allows the user to check in at a place visited by the user, is installed. Checking-in is an example of a position-related service provided to the smartphone terminal 30 of the user via a network or a communication line.

The program of the application, installed in the smartphone terminal 30, communicates with the program of the application, installed in the information providing device 100, via the Web Application Programming Interface (Web API) to carry out data communication necessary for executing the application.

When the user of the smartphone terminal 30 selects, and checks in at, a predetermined store, facility or the like using the check-in function with the application activated, the information providing device 100 registers the spot ID identifying the spot of the selected store or facility, the user ID of the smartphone terminal 30, and so on in the check-in list in which all these items are associated with each other.

The information providing device 100 includes a main control unit 111, a position acquisition unit 112, a behavior acquisition unit 113, an importance degree derivation unit 114, a behavior history generation unit 115, an analysis unit 116, a selection unit 117, a communication unit 118, a guide unit 119, a map Data Base (DB) 131, a spot DB 132, an importance degree DB 133, a behavior history DB 134, a content DB 135, and a guide data DB 136.

The information providing device 100 performs similar processing in parallel for a plurality of users. Therefore, the following describes the processing that is performed when one specific user uses the particular vehicle 10 and the particular smartphone terminal 30. In this scene, the information providing device 100 communicates with the on-vehicle apparatus 20, installed in the vehicle 10, and the smartphone terminal 30 to perform predetermined processing as described below.

In the description below, the ID of the user is referred to as a user ID. The information providing device 100 holds the user ID, the ID of the on-vehicle apparatus 20, and the ID of the smartphone terminal 30 in association with each other. Therefore, the information providing device 100 can convert the ID of the on-vehicle apparatus 20 to the user ID, and the ID of the smartphone terminal 30 to the user ID.

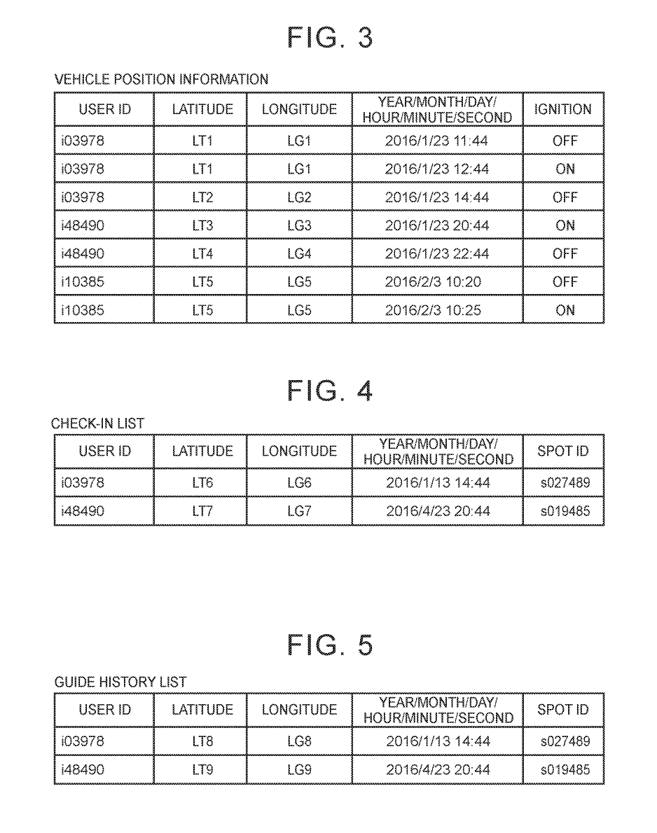

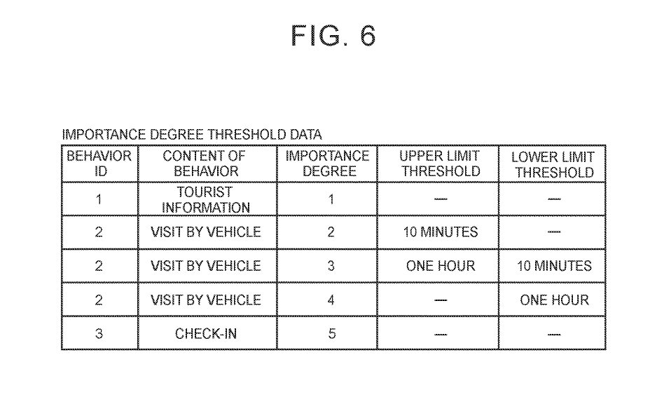

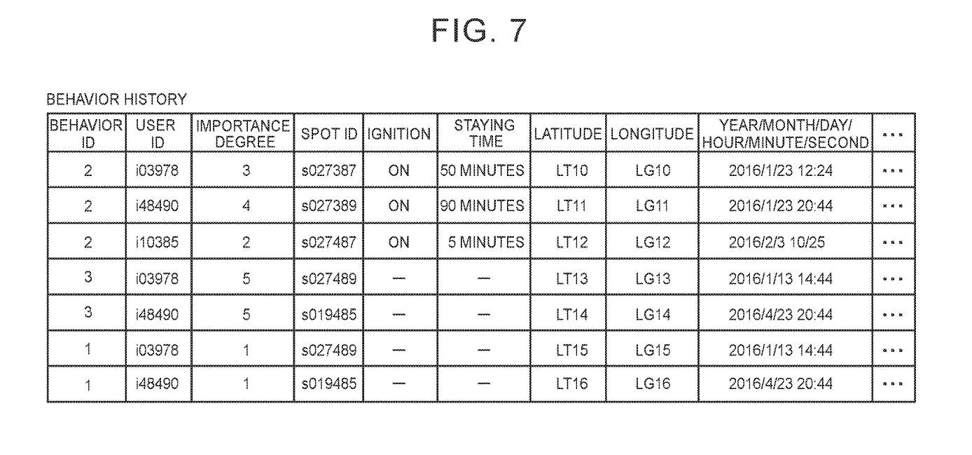

In the description below, reference is made not only to FIG. 2 but also to FIGS. 3 to 7. FIG. 3 is a diagram showing the position information on the vehicle 10. FIG. 4 is a diagram showing a check-in list. FIG. 5 is a diagram showing a guide history list. FIG. 6 is a diagram showing importance degree threshold data. FIG. 7 is a diagram showing a behavior history.

The main control unit 111 is a control unit that integrally performs the control processing for the information providing device 100. The main control unit 111 also performs processing different from that performed by the position acquisition unit 112, behavior acquisition unit 113, importance degree derivation unit 114, behavior history generation unit 115, analysis unit 116, selection unit 117, and communication unit 118.

The position acquisition unit 112 periodically acquires the position data and the ID of the on-vehicle apparatus 20 from the vehicle 10 via the communication unit 118 (for example, every one minute or five minutes). In addition, the position acquisition unit 112 acquires the position data and the ID of the on-vehicle apparatus 20 from the vehicle 10 when the behavior acquisition unit 113 receives the ignition signal from the vehicle 10 and when the guide unit 119 outputs the information on a tourist spot in response to a request from the on-vehicle apparatus 20.

The behavior acquisition unit 113 performs processing for acquiring data representing the user's behavior content. More specifically, the behavior acquisition unit 113 performs the following processing.

The behavior acquisition unit 113 acquires the ignition signal and the ID of the on-vehicle apparatus 20 from the vehicle 10 via the communication unit 118 and, at the same time, acquires the position data corresponding to the ID of the on-vehicle apparatus 20 from the position acquisition unit 112. The behavior acquisition unit 113 generate the position information on the vehicle 10 based on the ignition signal by associating the date and time (year, month, day, and time of day), at which the ignition is turned on or off, with the user ID and the position data.

The period of time from the time when the ignition was turned off to the time when the ignition was turned on is considered to be the period of time during which the vehicle 10 stayed at the position indicated by the position data (place of a facility, and so on). The ID of the on-vehicle apparatus 20 is converted to the user ID, which is registered in the position information on the vehicle 10.

As shown in FIG. 3, the position information on the vehicle 10 is represented by the tabular data that indicates the correspondence among the user ID, position data (latitude and longitude), date and time (year, month, day, and time of day), and ignition state (ON or OFF). The latitude and longitude of the position data are indicated by the symbols (LT1 to LT5, LG1 to LG5).

In addition, the behavior acquisition unit 113 acquires check-in information from the smartphone terminal 30 via the communication unit 118. Using the acquired check-in information, the behavior acquisition unit 113 associates the position data (latitude and longitude) on the spot of the store or facility where the user checked in, the spot ID that identifies the spot, the user ID of the user of the smartphone terminal 30, and the date and time (year, month, date, and time of day) at which the user checked in and, then, registers the associated data items in the check-in list as shown in FIG. 4. The check-in list shown in FIG. 4 is tabular data in which these data items are associated with each other. The position data on the spot is acquired from the smartphone terminal 30. In FIG. 4, the latitude and longitude of the position data are indicated by the symbols (LT6 to LT7, LG6 to LG7).

In addition, the behavior acquisition unit 113 acquires the position data from the position acquisition unit 112 when the guide unit 119 outputs information on a spot, such as a tourist spot, in response to a request from the on-vehicle apparatus 20. Using the acquired position data on the spot, the behavior acquisition unit 113 associates the position data (latitude and longitude), the user ID, the date and time (year, month, day, and time of day) at which the information on the spot such as a tourist spot was output, and the spot ID of the spot where the information was output and, then, registers the associated data items in the guide history list shown in FIG. 5. The information providing device 100 converts the ID of the on-vehicle apparatus 20, which requested to output the information on the spot, into the user ID and registers converted result in the guide history list. The guide history list shown in FIG. 5 includes tabular data in which these data items are associated. In FIG. 5, the latitude and longitude of the position data are indicated by the symbols (LT8 to LT9, LG8 to LG9).

The importance degree derivation unit 114 uses the importance degree threshold data, registered in the importance degree DB, to derive the importance degree of the user behaviors registered in the position information on the vehicle 10, the check-in list, and the guide history list. In this case, the importance degree refers to the degree of importance (to the user) of a behavior actually performed by the user up to the present time, and is an example of the score of a behavior actually performed by the user up to the present time. The importance degree is used as an index when analyzing the user's taste and behavior tendency.

As shown in FIG. 6, the importance degree threshold data is tabular data in which the behavior ID, behavior content, importance degree, upper limit threshold, and lower limit threshold are associated with each other. The behavior ID is an identifier (ID) used to distinguish the behaviors of each user. The behavior content indicates the specific content of a user's behavior. In this specification, the behavior content includes behaviors such as tourist information output, touring by the vehicle 10 (visit by the vehicle 10), and checking-in. The tourist information output means that the tourist information on a spot, such as a tourist spot, was output.

The importance degree is represented by five levels, 1 to 5, with level 5 indicating the highest importance degree and level 1 indicating the lowest importance degree. The upper limit threshold and the lower limit threshold are thresholds used for deriving the importance degree.

In this embodiment, checking-in is regarded as a user's behavior with the highest importance degree with its level set to level 5. When the user checks in at a certain place, it is considered that the user intends to record, for himself/herself, the fact that he/she has visited the place or the user intends to share that fact with a friend (friends) who uses an application having the check-in function. In other words, it is considered that the user is very much interested in the place and, therefore, checking-in is a behavior that has a high importance degree for the user. As described above, checking-in is a service that is used when the user has an active intention and a high interest and, therefore, its level is set to the highest level 5 considering that this service is a high-level, position-related service (importance degree is high). In the first embodiment, the level of a service is set higher as the user is assumed to have a more active intention and a higher interest and as the user was more positively provided with the service.

Conversely, when the tourist information is provided by an application that outputs information on spots, the importance degree is set to level 1 that is the lowest level. To receive the tourist information, it is necessary for the user to activate the application, which outputs the information on spots, using the on-vehicle apparatus 20. This application automatically outputs the tourist information when the vehicle passes by each spot and, therefore, it is unknown whether or not the user intends to actively receive the information for all spots. This means that there is a possibility that the user has not an intention to actively receive the tourist information on the spots. In addition, it is considered that the importance degree for the user is lower when the tourist information is output than when the user visits a spot by the vehicle 10 (this behavior will be described later). For this reason, the level of the output of tourist information on spots is set to the lowest level 1 considering that this service is a low-level, position-related service (importance degree is low). In the first embodiment, the level of a service is set lower as the user is assumed to have a less active intention and as the user was less positively provided with the service. Listening to the voice output of the tourist information is an example of the behaviors of the user.

The importance degree level of the behavior in which the user visits a spot by the vehicle 10 is set to one of three levels, 2 to 4, depending on the staying time. The staying time is determined by the behaviors included in the position information (see FIG. 3) on the vehicle 10. That is, the staying time is represented by the difference between the dates/times (year, month, day, and time of day) of two consecutive behaviors which were performed when the ignition was switched from the OFF state to the ON state and, in addition, the position data (latitude and longitude) of the two consecutive behaviors are equal.

Which of levels 2 to 4 is to be set is determined as follows using the upper limit threshold (for example, one hour) and the lower limit threshold (for example, 10 minutes). When the staying time is equal to or longer than the upper limit threshold, the importance degree level of the behavior is set to level 4. When the staying time is shorter than the upper limit threshold and is equal to or longer than the lower limit threshold, the importance degree level is set to level 3. When the staying time is equal to or shorter than the lower limit threshold, the importance degree level is set to level 2. It is considered that the longer the staying time is, the higher is the interest of the user in the spot. Thus, the level is set to one of the three levels using the upper threshold and the lower threshold in this way.

The upper limit threshold and the lower limit threshold may be set to appropriate values according to the size and content of each spot. For example, if the spot is a temple that the user can tour everything in 30 minutes, the upper limit threshold may be set to 30 minutes and the lower limit threshold may be set to 10 minutes. If the spot is a bodily-sensation facility such as Mega Web in Tokyo (a showroom where the user can see, and take a test drive of, a vehicle), the upper limit threshold may be set to two hours and the lower limit threshold may be set to 10 minutes.

The behavior history generation unit 115 generates a behavior history representing the history of the actual behaviors of the user. As shown in FIG. 7, the behavior history includes the behavior ID, user ID, importance degree, spot ID, ignition signal (ON/OFF), staying time, position data (latitude, longitude), and date and time. The behavior history shown in FIG. 7 is tabular data in which these data items are associated. The behavior history, which represents the history of behaviors generated when the user actually behaves (geographically moves), is registered in the behavior history DB 134. In FIG. 7, the latitude and longitude of the position data are indicated by the symbols (LT10 to LT16, LG10 to LG16).

If there is a plurality of importance degree levels for the same user with respect to the spot specified by the same spot ID, the behavior history generation unit 115 selects the importance degree having the highest level from the plurality of importance degrees and registers the selected importance degree in the behavior history as the importance degree for the spot of the user.

For example, assume that the user visited a certain temple by the vehicle 10. In this case, if the on-vehicle apparatus 20 output the tourist information on the temple, if the staying time at the temple exceeded the upper limit threshold, and if the user checked in at the temple, three importance degrees, Level 1 (tourist information output), Level 4 (staying time equal to or longer than the upper limit), and Level 5 (checking-in), are derived for the spot ID of the temple. In such a case, the behavior history generation unit 115 registers the importance degree of level 5 (checking-in) in the behavior history for the spot ID of the temple. This is because the highest level of the importance degree appropriately represents the importance of the spot to the user.

The analysis unit 116 analyzes the user's taste or behavior tendency based on the behavior history. The analysis unit 116 checks the behaviors, included in the behavior history, to extract (analyze) the category of the spot ID of a behavior, whose importance degree is equal to or higher than the predetermined level, as the user's taste or behavior tendency.

Therefore, the user's taste or behavior tendency, which is analyzed by the analysis unit 116, is represented by the category of the spot ID of a spot actually visited by the user. In the first embodiment, the predetermined level is set, for example, to level 4. Therefore, the user's taste or behavior tendency is represented by the category of a spot ID having an importance degree of level 4 or higher.

The category of a spot ID, which refers to the genre of a spot (tourist spot, other facilities, etc.) related to the map data, is associated with the spot ID in the spot DB 132. The detail of the category of a spot ID will be described later together with the detail of the spot DB 132.

The selection unit 117 selects content, corresponding to the category extracted by the analysis unit 116, from the content DB 135. For example, when the category representing the user's taste is a car, the selection unit 117 selects car-related content from the content DB 135.

The information on the content, selected by the selection unit 117, may be sent via e-mail, for example, to the mail address of the user's smartphone terminal 30 or the Personal Computer (PC) at user's home periodically via the communication unit 118.

For example, if the user's taste is a meal in an Italian style food restaurant, the selection unit 117 may select content related to popular Italian style food restaurants and send the selected content by e-mail. In this case, the selection unit 117 may select the content of Italian style food restaurants, considering the area according to the user's address. For example, if the user's address is in Tokyo, the selection unit 117 may select the content of Italian style food restaurants in Tokyo and neighboring prefectures.

Similarly, if the user's behavior tendency is watching motor sports, the selection unit 117 may select content related to various car races to be held in the country and send the selected content by e-mail.

When selecting content corresponding to a category from the content DB 135, the selection unit 117 may use the position data to select content relating to the facilities within a predetermined distance (for example, 2 km) from the current position of the vehicle 10.

When the selection unit 117 selects content near the current position in this way, the content information may be sent from the communication unit 118 to the on-vehicle apparatus 20 at the time the content is selected. For example, if the user's behavior tendency is a drive and if the selection unit 117 selects content that introduces another nearby driving way while the user is traveling on a drive way along the sea by the vehicle 10, the selected content may be sent to the on-vehicle apparatus 20. Then, the image related to the other nearby drive way is displayed on the display unit 24 of the on-vehicle apparatus 20 and, at the same time, the voice guidance is output to allow the user to obtain information on the other nearby drive way.

Similarly, if the user's taste is a visit to a temple and a shrine and if the selection unit 117 selects content that introduces a temple or a shrine near the current position based on the position data while traveling by the vehicle 10, the selected content may be sent to the on-vehicle apparatus 20.

The communication unit 118 sends the content information, selected by the selection unit 117, to the on-vehicle apparatus 20 or to the smartphone terminal 30. Whether to send the selected content to the on-vehicle apparatus 20 or to the smartphone terminal 30 (or to both) may be set by the user in advance or may be set for each category by the information providing device 100.

The guide unit 119 selects guide data from the guide data DB 136 based on the position data when a request is received from the on-vehicle apparatus 20. The guide data is data used for outputting the information on tourist spots and other facilities near the current position of the vehicle 10. The selected guide data is sent to the on-vehicle apparatus 20 by the communication unit 118.

As a result, the on-vehicle apparatus 20 displays images relating to the spots near the current position of the vehicle 10 and, at the same time, outputs information on the spots via voice like a tour guide. A request that the guide unit 119 receives from the on-vehicle apparatus 20 is a request, issued by an application, to search for a spot at predetermined intervals (for example, at 5-minute intervals). This request is issued when this application has been activated in the on-vehicle apparatus 20 to output information on the spots near the current position.

The map DB 131 is a database in which map data is registered. The map data, which is data for drawing a map such as a route diagram for representing a traffic network, includes road map data and route diagram data. The road map data is, for example, map data meshed according to a scale (for example, first to third region partition mesh data of JIS standard, 100 m mesh data, etc.). More specifically, the road map data is image data for drawing a map in the raster format, vector format, or the like. The route diagram data is drawing data representing a route diagram obtained by diagramming the routes.

The spot DB 132 is a database in which spot data on the spots (tourist spots, other facilities, etc.) related to the map data is registered. The spot data is Point of Interest (POI) information. The POI information represents the ID (spot ID), name, category (genre), and position (latitude and longitude) of each of the stores and facilities along the road included in the map data.

For example, the category (genre) of a car includes categories such as a car (general), motor sport, dealer, car shop, car museum, motor show, circuit, racing school, drive way, car washing station, and auto camping site. The categories may be organized in a hierarchical structure in which categories such as a motor sport, . . . , auto camping site are arranged below the category of a car (general). The hierarchy may have three or more layers.

In addition to a car, the categories include, for example, a shrine and temple, beach, hiking trail, golf course, tennis court, swimming pool, fitness club, meal (general), hot spring, lodging facility (general), and so on. The categories may be organized in a hierarchical structure in which the categories of the Japanese style food (general), fast food, cafe, ramen (Chinese noodles in soup), Italian style food, French style food are arranged below the category of the meal (general). Similarly, the categories may be organized in a hierarchical structure in which categories such as a fish dish, teppan-yaki (Japanese cooking prepared on a hot steel plate in the center of the table), tempura, and so on are arranged below the category of the Japanese style food (general).

Similarly, the categories may be organized in a hierarchical structure in which the categories such as an inn, a guest house, a hotel, an auberge and so on are arranged below the category of the accommodation (general).

The POI information includes the following data: data on shapes of the features displayed on the map (for example, buildings, buildings such as houses and stations, roads, railroad tracks, bridges, tunnels, contour lines, water lines such as coastlines and lakeshore lines, sea, rivers, lakes, ponds, swamps, parks, and outdoor facilities, as well as administrative boundaries, administrative areas, contour lines, blocks, and so on), data on the notes displayed on the map (for example, place names, addresses, telephone numbers, names of facilities such as stores, parks and stations, names, including colloquial names, of famous places, historic sites, rivers, lakes, bays, mountains, forests, and so on, names of roads, bridges, and tunnels, route names, location information, personal communication information, and so on), and data on symbol data on symbols displayed on the map (for example, map symbols of mountains, historic sites, shrines, schools, hospitals, factories, and cemeteries, store symbols of gas stations, convenience stores, supermarkets, restaurants, banks, post offices, signs on the roads, symbols of facilities such as entrances and exits of toll roads, toll gates, service areas (SA), and parking areas (PA), and interchange (IC), and facility symbols of parking lots, stations, hotels, art museums, and museums).

The importance degree DB 133 is a database in which importance degree threshold data is registered (see FIG. 6).

The behavior history DB 134 is a database in which a behavior history is registered (see FIG. 7). The behavior history is created by the behavior history generation unit 115.

The content DB 135 is a database in which content data selected by the selection unit 117 is registered. The content data registered in the content DB 135 is the Uniform Resource Locator (URL) of a web page corresponding to each category described above.

A web pages is a homepage, a blog, or an advertisements corresponding to each category. For example, for the category of a dealer, the home page of the dealer of each automobile manufacturer corresponds to the web page. Similarly, for the category of a motor sport, the homepage of “TOYOTA GAZOO Racing” corresponds to the web page. Similarly, for the category of a hotel, the homepage of each of the hotels across the nation corresponds to the web page.

The guide data DB 136 is a database in which guide data, used for outputting tourist information on tourist spots and other spots such as facilities, is registered. The guide data is data that associates a spot ID with tourist information on the spot (image and voice guide data).

In addition to the map DB 131, spot DB 132, importance degree DB 133, content DB 135, and guide data DB 136, the information providing device 100 may include a peripheral information DB in which peripheral information is registered.

The peripheral information DB is a database in which the information (peripheral information) displayed on the map as symbols, including at least the types and the names of the facilities, is registered. For example, this database includes the information on gas stations, convenience stores, supermarkets, department stores, restaurants, banks, post offices, parking lots, parks, toilets, stations, hotels, art museums, museums and so on. The peripheral information is used in the navigation device to extract information on stores, facilities, and the like around the current position of the vehicle 10.

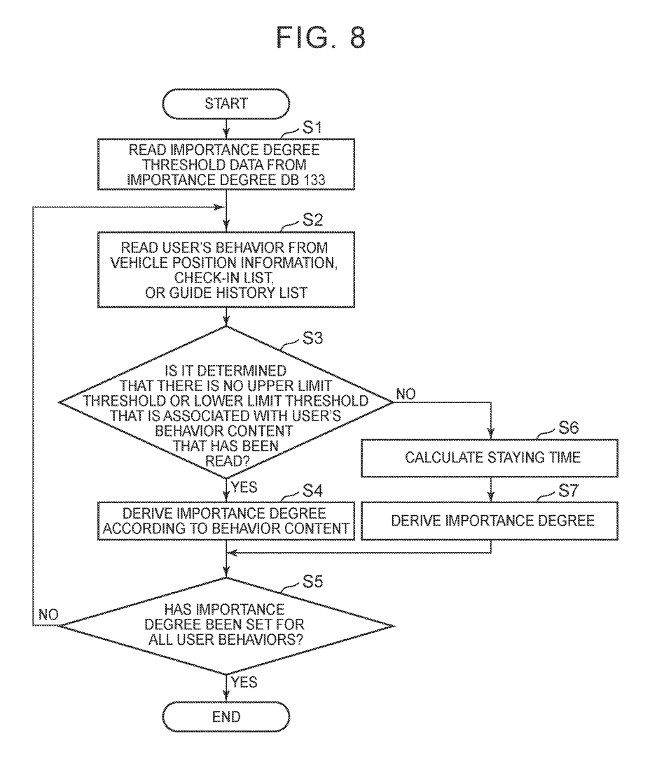

FIG. 8 is a flowchart showing the processing of the behavior history generation unit 115 for generating a behavior history. When the behavior history generation unit 115 generates a behavior history, the importance degree derivation unit 114 performs the processing for deriving the importance degrees.

The importance degree derivation unit 114 and the behavior history generation unit 115 start processing when the power supply is turned on (start).

The importance degree derivation unit 114 reads the importance degree threshold data from the importance degree DB 133 (step S1).

The behavior history generation unit 115 reads the user's behaviors from the vehicle position information (see FIG. 3), the check-in list (see FIG. 4), or the guide history list (see FIG. 5) (step S2).

The importance degree derivation unit 114 determines whether the user's behavior content, which was read in step 2, is a user's behavior with which an upper limit threshold or a lower limit threshold is not associated in the threshold degree threshold data (step S3). A user's behavior for which there is no upper limit threshold or lower limit threshold is checking-in or tourist information output.

If it is determined that there is no upper limit threshold or lower limit threshold (S3: YES), the importance degree derivation unit 114 derives the importance degree according to the behavior content using the importance degree threshold data (step S4). As shown in the importance degree threshold data (see FIG. 6), the importance degree is level 5 when the behavior content is the check-in, and level 1 when the behavior content is the output of tourist information.

When the processing in step S4 is completed, the behavior history generation unit 115 determines whether an importance degree has been set for all user behaviors included in the vehicle position information (see FIG. 3), the check-in list (see FIG. 4), and the guide history list (see FIG. 5) (step S5).

If it is determined that an importance degree has not been set for all users' behavior (S5: NO), the behavior history generation unit 115 returns to step S2 in the flow.

If it is determined that there is an upper limit threshold or an lower limit threshold (S3: NO), the importance degree derivation unit 114 calculates the staying time from the position information (see FIG. 3) of the vehicle 10 (step S6).

This is because, when the ignition was switched from OFF to ON with no change in the position data (latitude and longitude), it is considered that the vehicle 10 stayed at the position (place of facility etc.), indicated by the position data, for the period from the time when the ignition was turned OFF to the time when the ignition was turned ON.

The importance degree derivation unit 114 compares the staying time, calculated in step S6, with the upper limit threshold and the lower limit threshold to derive the importance degree (step S7). The importance degree is set to one of level 2, level 3, or level 4 depending on the length of the staying time. Upon completion of the processing in step S7, the processing proceeds to step S5 in the flow.

If it is determined that importance degree has been set for all users' behaviors (S5: YES), the behavior history generation unit 115 terminates the series of processing (end). As a result, the behavior history, such as the one shown in FIG. 7, is generated and is registered in the behavior history DB 134.

After the behavior history is generated as described above, the analysis unit 116 extracts (analyzes) the category of a spot ID, which is included in the behavior history and whose importance degree is level 4 or higher, as the user's taste or behavior tendency.

Then, the selection unit 117 selects the content corresponding to the category, extracted by the analysis unit 116, from the content DB 135 and provides the selected content to the user. For this reason, it is possible to select content that is important to the user and is suitable for the user's taste and behavior tendency and to provide the selected content to the user.

The content provided to the user is extracted based on the degree of importance to the user of a behavior actually performed by the user. The degree of importance to the user of a behavior actually performed by the user is a score reflecting the user's taste and behavior tendency.

For example, if content that does not reflect the user's taste and behavior tendency is provided to the user, there is a case that the content does not match the preference of the user. In such a case, there is a possibility that content not useful for user is provided.

On the other hand, the information providing device in the first embodiment analyzes the behaviors with a high degree of importance to the user to identify the user's taste and behavior tendency based on the behaviors actually performed by the user and, then, provides the content (recommendation information) that suits the user's taste and behavior tendency.

Accordingly, it is possible to provide the information providing device 100 capable of selecting and providing appropriate information according to user's taste and behavior tendency.

When the user is not in the vehicle 10, the smartphone terminal 30 may perform the processing performed by the on-vehicle apparatus 20. In this case, the user of the smartphone terminal 30 can obtain the recommendation information while moving by a vehicular unit other that the vehicle 10 in the same way as described above for the user of the vehicle 10. That is, in this case, the processing may be performed by the smartphone terminal 30 and the information providing device 100.

When the user rents a car and turns on the ignition, the information providing device 100 may provide content, suitable for the user's taste and behavior tendency, to the on-vehicle apparatus 20 of the rental car. For example, the ID of the on-vehicle apparatus 20 of the rental car and the user ID of the user may be sent to the information providing device 100 from the computer of the rent-a-car office to associate the on-vehicle apparatus 20 of the rental car with the user.

In the mode described above, the behavior acquisition unit 113 acquires check-in information from the smartphone terminal 30 via the communication unit 118. In this mode, the application for generating check-in information may be any application and, in addition, check-in information may be acquired from an existing application that has the check-in function.

In the mode described above, checking-in is a user's behavior with the highest importance degree. However, if a function other than the check-in function can generate a record indicating that the user has been to a certain place, the record generated by this function may be used as a user's behavior with the highest importance degree.

In the above description, the information providing device 100 is described that analyzes user 's taste and behavior tendency using importance degree and provides content suitable for the analyzed taste and behavior tendency. However, the information providing device 100 may be used as an information analyzing apparatus that analyzes user's taste and behavior tendency using the importance degree but does not provide the content to the user.

### Second Embodiment

An information providing device 100 in a second embodiment has the same configuration as the information providing device 100 in the first embodiment. Therefore, the information providing device 100 in the first embodiment is used in the the description below with emphasis on the differences.

The second embodiment is different from the first embodiment in that the analysis unit 116 and the selection unit 117 perform the additional processing in addition to the processing of the analysis unit 116 and the selection unit 117 in the first embodiment. In the second embodiment, the information provided from the information providing device 100 to another user, who has a taste or behavior tendency similar to that of one user (for example, the user himself or herself), is provided also to the one user.

To implement such processing, the analysis unit 116 divides a number of users into groups, each composed of users having a similar taste or behavior, based on their taste or behavior tendency. Then, the selection unit 117 provides the information, in which one user of a group is interested, to the other users in that group. The processing for implementing such a method will be described below.

The analysis unit 116 uses expression (1), given below, to calculate the degree of interest X that represents the degree of interest that the user has in a thing or an object of a certain category. A “category” used in the expression is the category of a spot ID as in the first embodiment.

$$X = \frac{{\sum }_{K = 1}^{m} ( {IM}_{k} of one category )}{{\sum }_{k = 1}^{m} {IM}_{k}} \qquad ( 1 )$$

where, “m” is the number of importance degrees included in the user's behavior history (m is an arbitrary integer greater than or equal to 2) and, as a general expression, an importance degree is expressed as IMk (1≦k≦m). Expression (1) represents the ratio of the total of all importance degrees IMk, included in the user's behavior history and related to one category, to the total of all importance degrees IMk, included in the user's behavior history, as the degree of interest X in percentage terms.

For example, for the category of a car, the numerator of expression (1) is the total of the importance degrees of Toyota museum, AUTOBACS, and Fuji Speedway that are included in the user's behavior history. The denominator is the total of all importance degrees included in the behavior history of the user. Similarly, when the large (higher level) category “meal” includes lower level categories such as the Italian style food, French style food, Japanese style food, and fast food, the total of the importance degrees of each of the Italian style food, French style food, Japanese style food, and fast food is calculated as the numerator of expression (1). Then, the user's degree of interest, X_{IT}, X_{FR}, X_{JP}, and X_{FF}, in each of the Italian style food, French style food, Japanese style food, and fast food to all the behaviors included in the behavior history of the user can be calculated.

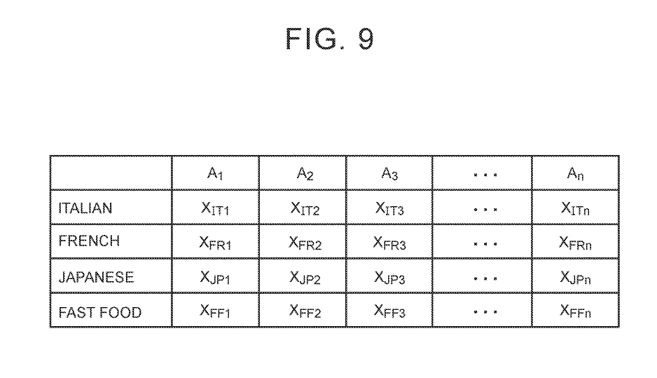

FIG. 9 is a diagram showing the degrees of interest X_{IT}, X_{FR}, X_{JP}, and X_{FF} of a plurality of users in each of the Italian style food, French style food, Japanese style food, and fast food. In this figure, the plurality of users are represented by A₁ to Aₙ. “n” is an arbitrary integer of 2 or larger and, in this figure, an integer of 4 or larger is used as an example. The degrees of interest of the users A₁ to Aₙ in the Italian style food, French style food, Japanese style food, and fast food are represented respectively as X_{IT1} to X_{ITn}, X_{FR1} to X_{FRn}, X_{JP1} to X_{JPn}, and X_{FF1} to X_{FFn}. The degree of interest, which represents a user's taste or behavior tendency for a certain category, is expressed by the ratio calculated by expression (1).

Next, using the degree of interest described above, the analysis unit 116 calculates the degree of matching X, in the interests of n users, A1 to An, by expression (2) given below. More specifically, two persons (Aᵢ and Aⱼ) are extracted, one pair at a time, from users A₁ to Aₙ, to calculate the degree of matching λ_{i,j} between two users, Aᵢ and Aⱼ, in the round robin manner. Note that i is 1 to n-1, j is 2 to n, and i and j are different values.

λ_{i,j}=|X_{ITi}−X_{ITj}|+|X_{FRi}−X_{FRj}|+|X_{JPi}−X_{JPj}|+|X^{FFi}−X_{FFj}| (2)

In this processing, for any two of n users A₁ to Aₙ, the total of the differences in the degrees of interest, X_{IT1} to X_{ITn}, X_{FR1} to X_{FRn}, X_{JP1} to X_{JPn}, X_{FF1} to X_{FFn}, in the Italian style food, French style food, Japanese style food, and fast food, is calculated.

As the difference in the degrees of interest in the same category is smaller, it is considered that the degree of matching in the degrees of interest in that category between the two users, Aᵢ and Aⱼ, is higher. For this reason, as the total of the differences in the degrees of interest (degree of matching λ_{i,j}) in a plurality of categories is smaller, it is considered that the matching in the degrees of interest in the higher level category “meal” between the two users, Aᵢ and Aⱼ, is high.

For this reason, the analysis unit 116 calculates the degree of matching between two users, Aᵢ and Aⱼ, using expression (2) in the round robin manner. If the degree of matching λ_{i,j} between two users, Ai and Aj, is equal to or less than the predetermined value, they become the members of the same group regarding the meal.

When such processing is performed, not only two users Aᵢ and Aⱼ, but also the users, each of whom is one of the users A₁ to Aₙ and has high a high degree of similarity with the user Aᵢ or Aⱼ in the degree of interest in the meal, are further included in the same group regarding the meal.

Now, assume that users A2, A5, and A8 are the members of the same group regarding the meal. In such a case, the selection unit 117 performs the following processing for users A2, A5, and A8 who have been classified into the group by the analysis unit 116.

The selection unit 117 provides user A2 with the content related to the meal that is provided to users A5 and A8. Similarly, the selection unit 117 provides user A5 with the content related to the meal that is provided to users A2 and A8, and user A8 with the content related to the meal that is provided to users A2 and A5.

The content related to the meal that is provided to user A5 is determined as follows. From the behavior history of user A5, the analysis unit 116 extracts (analyzes) the categories of spot IDs of behaviors whose importance degree is level 4 or higher. The content related to the meal that is provided to user A5 is the content that is selected by the selection unit 117 based on the extracted categories and is related to the meal.

As described in the first embodiment, the selection unit 117 can select content corresponding to the category, extracted by the analysis unit 116, from the content DB 135. Therefore, as in the first embodiment, the selection unit 117 may provide the content, which is included in the content selected from the content DB 135 and whose category is related to the meal, to user A2 based on the behavior history of user A5. Similarly, as in the first embodiment, the selection unit 117 may provide the content, which is included in the content selected from the content DB 135 and is related to the meal, to user A2 based on the behavior history of user A8.

As described above, the content related to the meal that is provided to users A5 and A8 may be provided to user A2. Similarly, the content related to the meal that is provided to users A2 and A8 may be provided to user A5, and the content related to the meal that is provided to users A2 and A5 may be provided to user A8.

In the example described above, the analysis unit 116 creates a group regarding the meal and the selection unit 117 selects content whose category is the meal. In this way, the analysis unit 116 may create groups for other various categories and the selection unit 117 may select content corresponding to the category of each group.

By performing the processing in this way, the content selected by the selection unit 117 for another user having a high degree of similarity with one user in the interest is provided also to the one user in various categories.

Therefore, as with the information providing device in the first embodiment, the information providing device in the second embodiment analyzes behaviors with a high importance degree for the user, based on the behaviors actually performed by the user, to identify the user's taste and behavior tendency and provides the content (recommendation information) that suits the user's taste and the user's behavior tendency.

Furthermore, according to the second embodiment, the content selected for another user having a high degree of similarity with one user in the interest is provided also to the one user. This allows the user to obtain information from the content intended for another user having a similar taste or behavior tendency, thus helping to increase the extent and depth of the user's hobbies and the like.

Although the information providing device according to the exemplary embodiments of the present invention has been described above, it should be noted that the present invention is not limited to the specifically disclosed embodiments and that various modifications and changes may be added without departing from the scope of the invention.

What is claimed is:

1. An information providing device comprising a server configured to:
acquire position information representing a position of a user;
derive a score of a behavior of the user at the position;
analyze a taste of the user or a behavior tendency of the user based on the score;
select recommendation information based on the taste or the behavior tendency of the user; and
send the selected recommendation information to a terminal of the user.

2. The information providing device according to claim 1, wherein
the server is configured to derive, as the score of the behavior, a score of a service or a score that represents a degree of staying of the user at the position, the score of the service being related to the position and being provided to the terminal at the position via a network or a communication line.

3. The information providing device according to claim 1, wherein
the server is configured to analyze that the user has a higher preference to the taste or a higher level of the tendency as the score is larger.

4. The information providing device according to claim 1, further comprising:
a spot database in which position information representing a position of a spot included in map data is associated with a category of the spot, wherein
the server is configured to
generate a behavior history by registering a spot corresponding to the acquired position of the user, and the score in such a way that the spot and the score are associated, the behavior history representing the behavior of the user and
extract a category of a spot corresponding to the position, included in the behavior history, where the score is equal to or larger than a predetermined value, as the taste of the user or the behavior tendency of the user.

5. The information providing device according to claim 4, wherein
the server is configured to
calculate a ratio of a total of scores corresponding to a spot of a particular category included in the behavior history to a total of all scores included in the behavior history,
generate, for the particular category, a group of a plurality of users whose degree of matching in the ratio is equal to or larger than a predetermined degree, and
select the recommendation information, selected for other users in the plurality of users in the group, as recommendation information that suits the taste or the behavior tendency of the user.

6. The information providing device according to claim 1, wherein
the score is a degree of importance of a spot at the position for the user.

7. The information providing device according to claim 1, wherein
the server is configured to derive a score based on at least one of content of a service for the position provided to the terminal via a network or a communication line at the position and a length of time during which the user stayed at the position, as the score of the behavior of the user.
